(19) United States
(12) Patent Application Publication
(10) Pub. No.: US 2018/0264895 A1
(43) Pub. Date: Sep. 20, 2018

(54) RADIO-BASED VEHICULAR DIAGNOSTIC SYSTEM

(71) Applicant: VORBECK MATERIALS CORP., JESSUP, MD (US)

(72) Inventors: John S Lettow, Washington, DC (US); Trentice V Bolar, Washington, DC (US)

(73) Assignee: VORBECK MATERIALS CORP., JESSUP, MD (US)

(21) Appl. No.: 15/540,133

(22) PCT Filed: Jan. 27, 2016
(86) PCT No.: PCT/US16/15039

§ 371 Date: Aug. 16, 2017

Related U.S. Application Data
(60) Provisional application No. 62/099,503, filed on Jan. 3, 2015.

(51) Int. Cl. B60C 11/24; G07C 5/00; G07C 5/08; B60C 23/04

(52) U.S. Cl. CPC B60C 11/246; B60C 23/0427; G07C 5/085; G07C 5/008

(57) ABSTRACT

Embodiments of the present invention relate to tracks and a related monitoring system. In some embodiments of these teachings, the track can include one or more ground contacting elements (“GCE”) having rubber. Within each GCE, one or more integrated circuits (“IC”) are positioned. One or more conductive elements are positioned within each GCE. Each conductive elements is positioned external to but in electrical communication with of the ICs. Each conductive element is applied on an elastomer. Each conductive element includes one or more conductive compositions having fully exfoliated individual graphene sheets.

### CROSS-REFERENCE TO RELATED APPLICATIONS

This application is a 371 application of PCT/US16/15039 filed Jan. 27, 2016, which claims priority to U.S. Provisional Application No. 62/099,503 filed Jan. 3, 2015, which is hereby incorporated herein by reference.

### BACKGROUND

The present invention relates generally to diagnostic systems and specifically to radio-based vehicular diagnostic systems. The tread of a tire or track refers to the rubber on its circumference that makes contact with the road or ground. Over the life of a tire or track, the tread depth typically reduces, limiting its effectiveness in providing traction.

Tread wear is often related to safety. Typically, as tread depth reduces due to wear, the vehicle's handling may respond poorly. Tires, tracks, or track pads having adequate tread depth generally exhibit desirable gripping and/or handling. Inadequate tread depth may increase the wear of other vehicle parts. In general, knowledge of the need to address the operational health of tires, tracks, or track pads presents itself during vehicle servicing or subsequent to a deterioration of vehicle performance (i.e. tire blowout, deterioration in vehicle handling, and flat tire).

### BRIEF DESCRIPTION OF THE DRAWINGS

FIG. 1 depicts an environment, generally 100, in accordance with an embodiment of the present invention.

FIG. 2 illustrates the positioning of an antenna in a vehicle, in accordance with an embodiment of the present invention.

FIG. 3 illustrates the layout of the components of a unit in a wheeled vehicle, generally 300, in accordance with an embodiment of the present invention.

FIG. 4 illustrates the operational steps of a program, in accordance with an embodiment of the present invention.

FIG. 5 depicts the cross section of a tire, generally 501, in accordance with an embodiment of the present invention.

FIG. 6 illustrates the operational steps of the program, in accordance with an embodiment of the present invention.

FIG. 7 depicts a portion of a tread, generally 700, in accordance with an embodiment of the present invention.

FIG. 8 illustrates the operational steps of the program, in accordance with an embodiment of the present invention.

FIG. 9 depicts a block diagram of components of a computing device, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The tread of a tire or track refers to the rubber on its circumference that makes contact with the road or ground. Over the life of a tire or track, tread depth typically reduces, limiting its effectiveness in providing traction. Tread wear is often related to safety. Typically, as tread depth reduces due to wear, the vehicle's handling may respond poorly. Tires, tracks, or track pads having adequate tread depth generally exhibit desirable gripping and/or handling. Inadequate tread depth may increase the wear of other vehicle parts. In general, knowledge of the need to address the operational health of tires, tracks, or track pads presents itself during vehicle servicing or subsequent to a deterioration of vehicle performance (i.e. tire blowout, deterioration in vehicle handling, and flat tire). As used herein, the term “tread” is utilized to refer to a tire tread, a track tread, or a track pad.

Embodiments of the present invention seek to provide a radio frequency (RF)-based tread transponder. Other aspects of the present invention seek to provide a RF-based tread diagnostic system. Additional aspects of the present invention seek to provide a RF-based transponder that determines whether a particular tire, track, track section should be serviced, for example, rotated, balanced, and replaced. Certain aspects of the present invention seek to provide a method to determine the operational status of a tire, track, and/or track section. As used here, “operational status” refers to whether a tire, track, and/or track section requires replacement, balancing, and/or rotation. Vehicles compatible with the RF-based tread diagnostic system of the presentment invention, include but are not limited to, land-based vehicle's that utilized treads for mobility (i.e. automobiles, trucks, SUVs, buses, tanks, tractors, motorcycles) as well as airplanes, which utilize wheels for takeoff and landing.

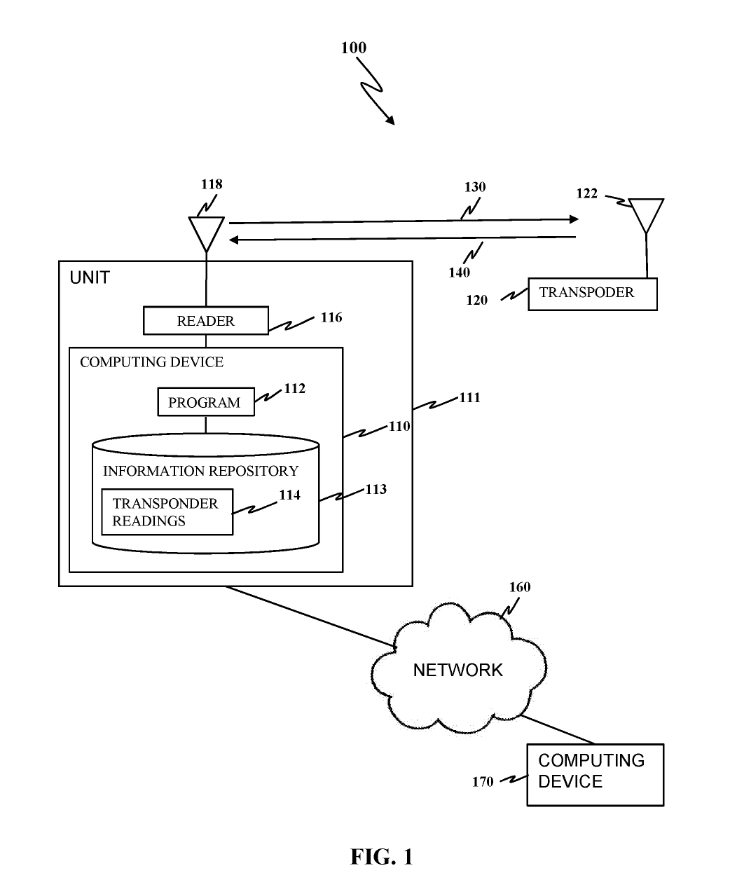

FIG. 1 depicts an environment, generally 100, in accordance with an embodiment of the present invention. Environment 100 comprises computing device 170, unit 111, and transponder 120. Unit 111 and computing device 170 can communicate via network 160. Network 160 may be a local area network (LAN), a wide area network (WAN) such as the Internet, a cellular data network, any combination thereof, or any combination of connections and protocols that will support communications between computing devices 170 and unit 111, in accordance with an embodiment of the invention. Network 160 may comprise wired, wireless, and/or fiber optic connections.

Computing devices of the present invention, such as computing devices 170 and 110 (discussed below), may be a desktop computer, a laptop computer tablet computer, a personal digital assistant (PDA), a wearable computer, a cluster computer, or a smart phone. In general, computing device of the present inventor may be any electronic device or computing system capable of sending data, receiving data, and/or communicating with additional computing devices over network 160. Computing device 170 is a device that allows a user to monitor the output of computing device 110. Computing device 170 can receive readings from unit 111 in real-time or periodically at predetermined time periods.

Transponder 120 is a radio-based computing device that facilitates the ascertainment of the operational status of vehicular treads, in accordance with an embodiment of the present invention. Transponder 120 is in electrical communication with antenna 122. Transponder 120 can, via antenna 122, communicate with computing device 110. One or more copies of transponder 120 can be positioned in one or more tire treads, tank tread rubber pads, or in the treads of rubber tracks. Transponder 120 can include transponder 120 and antenna 122. Transponder 120 is a device that can, via antenna 122, emit identifying signals in response to received carrier signals, such as carrier signal 130. For example, the identifying signal can comprise a modulated coded identifying signal. Antenna 122 can operate in the near field and/or far field to provide desirable system performance. Antenna 122 can comprise a conductive element. Antenna 122 can comprise a metal, such as silver, gold, and/or copper. Antenna 122 can be a printed antenna comprised of an electrically conductive composition (“the composition”) that is formed on a substrate.

The composition can include individual graphene sheets, graphite, SWCNT, MWCNT, fullerenes, carbon black, bucky-balls, and/or conductive polymers. In certain embodiments, fully exfoliated individual graphene sheets (“graphene sheets”) are preferred over carbonaceous material, such as graphene sheets, graphite, SWCNT, MWCNT, fullerenes, carbon black, bucky-balls because of the superior structural and conductive properties of individual graphene sheets. The use of such carbonaceous material alone often results in the composition having poor comparative structural and conductive properties. The graphene sheets are substantially one atom thick, two-dimensional planar structures. The graphene sheets may be obtained chemical vapor deposition, reduction of an alcohol, oxidation, mechanical treatment, and/or thermal exfoliation. The composition can comprise polymers, such as thermosets, thermoplastics, and/or non-melt processible polymers.

The composition can comprise thickening agents, binders, and/or carriers. Applicable substrates include, but are not limited to, flexible and/or stretchable materials, silicones and other elastomers and other polymeric materials, metals, adhesives, heat-sealable materials, fabrics, clothing, glasses and other minerals, ceramics, silicon surfaces, wood, paper, cardboard, paperboard, and/or cellulose-based materials. Subsequent to applying the composition to a substrate, the composition can be cured using any suitable technique, including, but not limited to, drying and oven drying (in air or another inert or reactive atmosphere), UV curing, IR curing, drying, crosslinking, thermal curing, laser curing, IR curing, microwave curing or drying, and/or sintering. The composition can be applied to the substrate by printing, screen printing, drop casting, painting, spraying, and/or painting knife. The graphene, composition, substrates, and/or application methods can be derived and/or accomplished utilizing a variety of methods, including, but not limited to, those disclosed by, for example, U.S. Pat. No. 7,658,901 B2 by Prud'Homme et al, U.S. Patent Application No. 2011/0189452 A1 by Lettow et al., McAllister et al. (Chem. Mater. 2007, 19, 4396-4404), U.S. Patent Application No. 2014/0050903 A1 by Lettow et al., and U.S. Pat. No. 8,278,757 B2 by Crain et al, which are hereby incorporated by reference in their entirety. The individual graphene sheets can be present in the composition in a three-dimensional connected network wherein individual graphene sheets are separated on at most a nanoscale basis.

Transponder 120 can be a radio frequency (“RF”) transponder. In certain embodiments, transponder 120 is a radio frequency identification (“RFID”) tag. Transponder 120 may comprise an active or a passive RFID integrated circuit (IC). As used herein, an active RFID IC is an IC that comprises an internal power source and a passive RFID IC is an IC that lacks an internal power source. The range of passive RFID tags is typically determined by the RF voltage received by the tag's power conditioning circuits. In brief, when a RF signal, for example, carrier signal 130, passes through the antenna of a passive RFID tag, there is an AC voltage generated across the antenna, which is rectified to result in a DC voltage for the passive RFID tag's operation. The passive RFID tag becomes functional when the DC voltage reaches a predetermined level at which time information stored in the device can be transmitted, for example, in about an omnidirectional manner, wherein a portion of the transmission is received by a reader, for example, reader 116 (discussed below).

Antenna 122 can receive carrier signal 130, which may allow transponder 120 to generate backscattering signal 140 (discussed below) that can have a range of up to about 2 feet. Transponder 120 can be powered via carrier signal 130. Transponder 120 can, via antenna 122, “rebroadcast” or “reflect” RF energy received from antenna 118 via backscattering signal 140. The rebroadcasting or reflection is termed “backscattering”. Transponder 120 can broadcast the received RF energy in a pattern determined by transponder 120 in a predefined coded format. Transponder 120 can transmit backscattering signal 140 in a manner wherein most of the energy typically is not redirected “back” to transmitting antennas, such as antenna 118. Transponder 120 can transmit backscattering signal 140 in about an omnidirectional pattern, such as a near spherical volume having transponder 120 positioned proximate to the middle.

Unit 111 determines the operational status of tires, tracks, and/or track pads, in accordance with an embodiment of the presence invention. Unit 111 may comprise reader 116 and computing device 110. Unit 111 may be included in the same vehicle associated with transponder 120. Unit 111 may be a handheld or vehicle-based unit. Unit 111 may be included in repair shop equipment. Unit 111 may be a mobile unit. Computing device 110 is in electrical communication with reader 116. Reader 116 is a radio frequency interrogator that communicates with radio-based transponders, in accordance with an embodiment of the present invention. Reader 116 can be in electrical communication with one or more copies of antenna 118. Antenna 118 can be positioned in the wheel well of a vehicle. Antenna 118 can be positioned proximate to the general location of transponder 120. Antenna 118 can be positioned proximate to a tank skirt. Reader 116 can communicate with active and passive radio-based transponders.

Reader 116 can via antenna 118 communicate with transponder 120. Reader 116 can, via antenna 130, transmit carrier signal 130 to transponder 120. Reader 116 can, via antenna 118, receive backscatter signal 140 from transponder 120. Information repository 113 can comprise transponder readings 114. Transponder readings 114 can comprise information generated by program 112. Transponder reading 114 can comprise data associated with transponder 120. Transponder reading 114 can comprise historic data associated with transponder 120. Program 112 is software that determines the operational status of one or more vehicular treads, in accordance with an embodiment of the present invention. Program 112 can be included in computing device 110.

Program 112 can be in communication with information repository 113. Program 110 can, via computing device 110, receive data from reader 116. Program 110 can determine the presence of transponder 120. Program 110 can determine the operational status of the vehicular treads that is associated with transponder 120. Program 112 can generate notifications that reflect a requirement to service the tread, tire, and/or track (i.e. replace, balance, or rotate the associates tire(s), tracks, and/or treads).

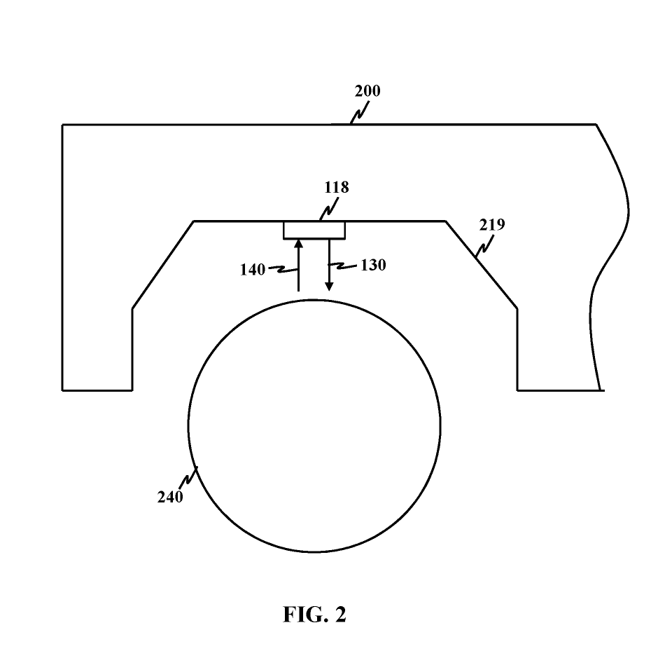

FIG. 2 illustrates the positioning of vehicular diagnostic components in a vehicular, in accordance with an embodiment of the present invention. Area 200 is a portion of a wheeled vehicle comprising wheel well 219 and tire 240. Wheel well 219 can include at least one copy of antenna 118 positioned proximate to the tire facing surface of wheel well 219. Although not shown, antenna 118 may positioned on the interior facing surface of wheel well 219. Tire 240 includes one or more copies of transponder 120 (not shown) embedded within the treads. Antenna 118 can transmit carrier signal 130 to the one or more copies of transponder 120 and/or receive backscattering signal 140 from the one or more copies of transponder 120.

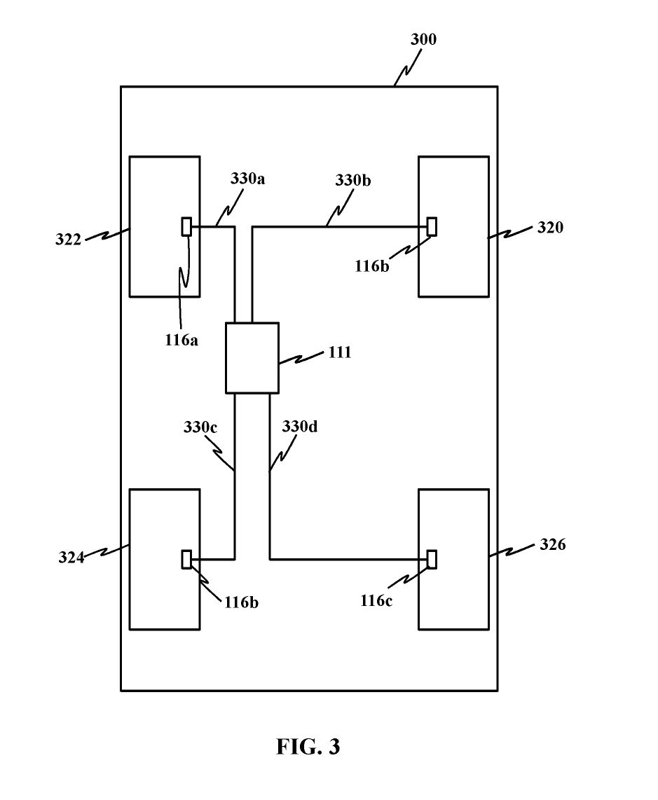

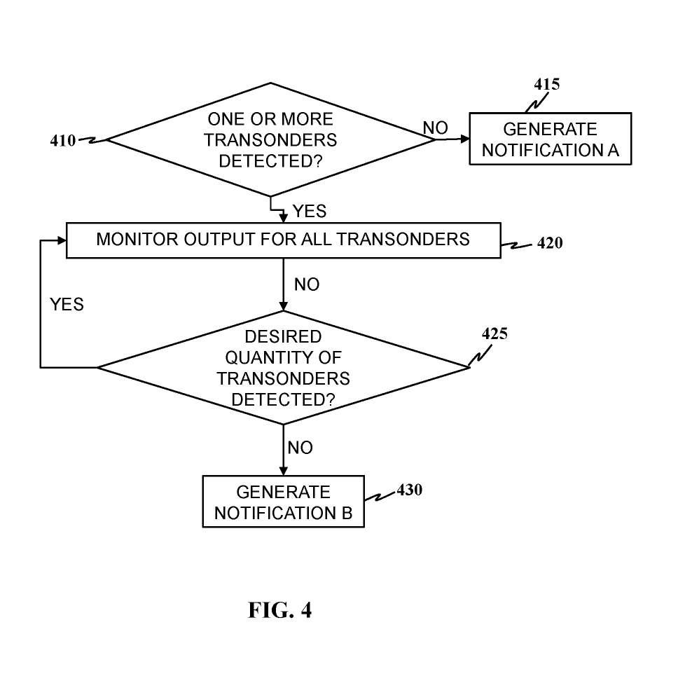

FIG. 3 is included herein to facilitate the discussion of FIG. 4. FIG. 3 illustrates the layout of the components of unit 110 in a vehicle, generally 300, in accordance with an embodiment of the present invention. Wheeled vehicle 300 includes unit 111 and tires 320, 322, 324, and 326. Unit 111 includes antennas 116a,b,c,d. Unit 111 is in electrical communication with readers 116a,b,c,d via communication lines 330a,b,c,d, respectively. Readers 116a,b,c,d are positioned proximate to tires 322, 320, 326, and 324, respectively.

Although not shown, tires 322, 320, 326, and 324 each may comprise at least one copy of transponder 120 embedded therein. In certain embodiments, each transponder copy can emit a signal comprising a unique code that is associated with a particular tire. Unit 111 can monitor the operational status of tires 320, 322, 324, and 326. For example, upon start up, program 112 determines whether reader 116 is functional by determining whether any of copies of transponders 120 are detected by reader 116. If program 112 determines that no copies of transponders 120 are detected by reader 116, program 112 generates notification A.

If program 112 determines that at least one copy of transponder 120 is detected by reader 116, program 112 proceeds to monitor the output generated by the copies of transponder 120. If program 112 determines that the copies of transponder 120 are emitting four particular types of unique signals that correspond to tires 320, 322, 324, and 326, program 112 continues to monitor the output of the copies of transponder 120. If program 112 determines the copies of transponder 120 are not emitting four particular types of unique signals that correspond to tires 320, 322, 324, and 326, program 112 generates notification B. The cessation of signals emanating from a particular copy of transponder 120 reflects that the transponder is damaged from exposure to the ground in response to the reduction of the tread depth. For example, notification B can reflect a need for one or more of tires 320, 322, 324, and/or 326 to be serviced.

FIG. 4 illustrates the operational steps of program 112, in accordance with an embodiment of the present invention. Program function 112 determines whether one or more transponders are detected (decisional 410). Upon sensing vehicle movement, if program 112 fails to detect one or more transponders (“no” branch decisional 410), program 112 generates notification A (step 415). If program 112 detects one or more transponders (“yes” branch decisional 410), program 112 monitor output for all transponders (step 420). If program 112 determines that the total number of transponders equals the desired quantity (“yes” decisional 425), program 112 continues to monitor the output for all transponders (step 420). If program 112 determines that the total number of transponders does not equal the desired quantity (“no” branch decisional 425), program 112 generates notification B.

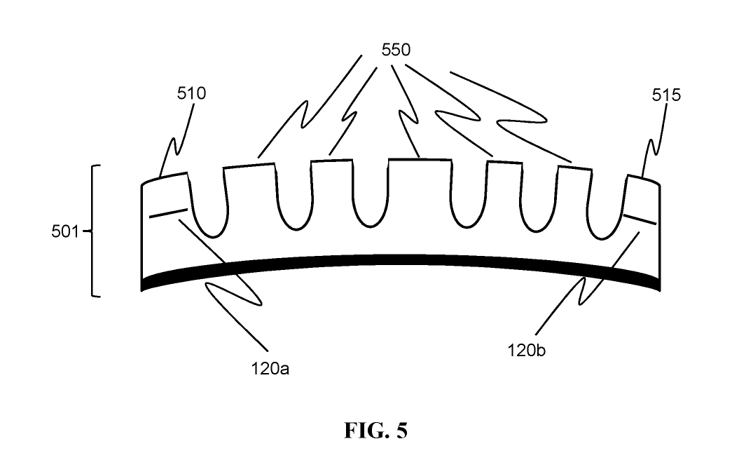

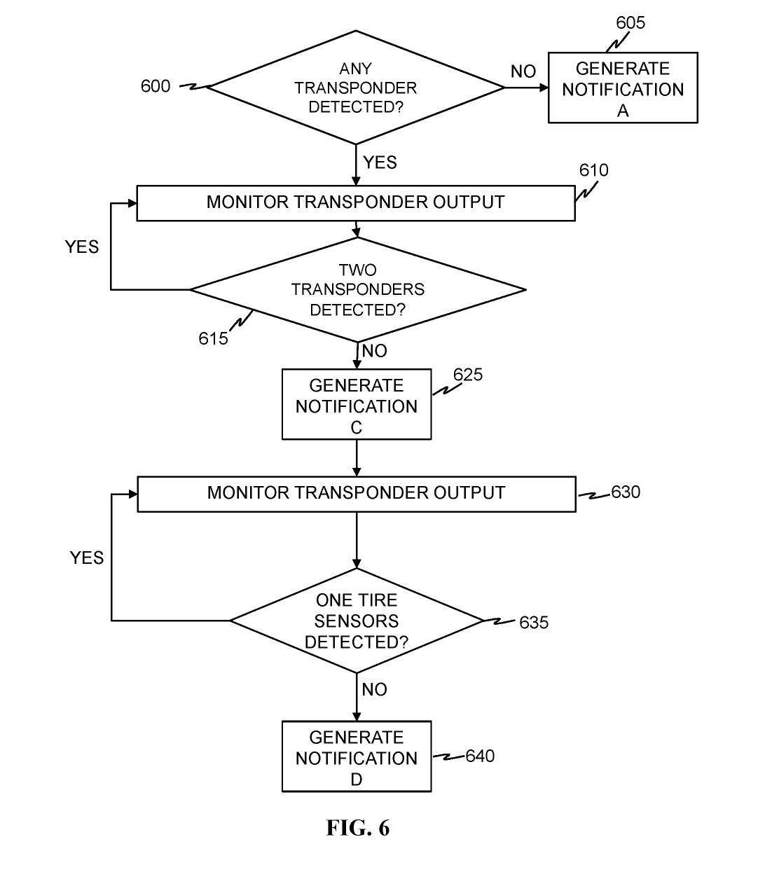

FIG. 5 is included herein to facilitate the discussion of FIG. 6. (discussed below). FIG. 5 depicts a portion of a tire, generally 501, in accordance with an embodiment of the present invention. Specifically FIG. 5 depicts a cut away cross-section view of the tread containing portion of tire 501. Tire 501 includes tread segments 510, 550, and 515. Tread segments 510 and 515 include transponders 120a and b embedded therein, respectively. Transponder 120a and b are copies of transponder 120 that can emit differing identification codes. Tread segments 500 lack copies of transponder 120. Treads 510 and 515 can be an inner and outer tread, respectively, or vice versa. In an embodiment, the depths of treads 510 and 515 should reduce in an even manner, which should result in the simultaneous loss of signals emanating from both transponders 120a and b. However, if the depth of treads 510 or 515 reduces prematurely one before the other, program 112 generates a notification.

FIG. 6 illustrates the operational steps of program 112, in accordance with an embodiment of the present invention. If program 112 fails to detect one or more transponders (“no” branch decisional 600), program 112 generates notification A (step 605). If program 112 detects one or more transponders (“yes” branch decisional 600), program 112 monitors transponder output (step 610). If program 112 detects two transponders (“yes” branch decisional 615), program 112 returns to step 610. If program 112 fails to detect two transponders (“no” branch decisional 615), program 112 generates notification C (step 625

Program 112 continues to monitor transponder output (step 630). If program function detects one transponder (“yes” branch decisional), program 112 returns to step 630. If program function does not detect one transponder (“no” branch decisional), program 112 generates notification D.

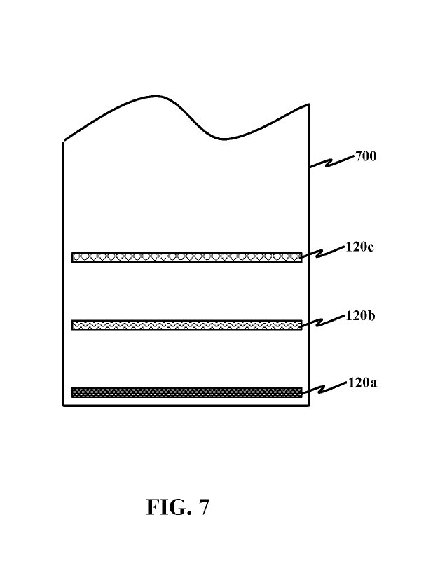

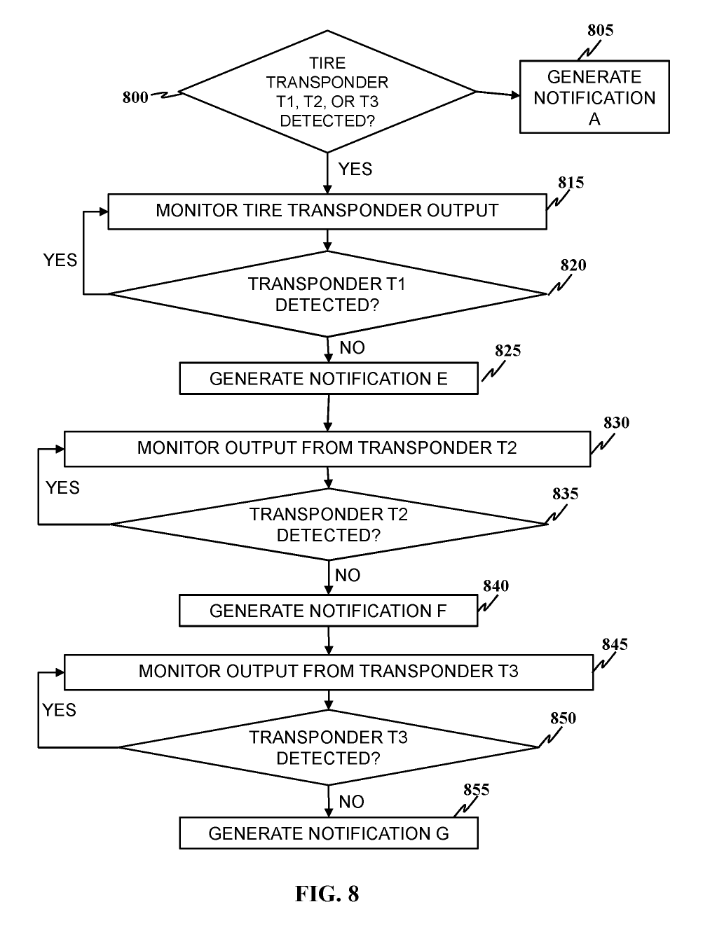

FIG. 7 is discussed herein to facilitate the discussion of FIG. 8 (discussed below). FIG. 7 depicts a portion of a tread, generally 700, in accordance with an embodiment of the present invention. Specifically, FIG. 7 is a close up cut through of a cross-section of tread 700. Tread 700 includes transponders 120a,b, and c embedded therein. For example, transponder 120a is positioned within tread 700 proximate to the tread's point of contact; transponder 120b is positioned above and proximate to transponder 120a at a predetermined distance; and transponder 120c is positioned above and proximate to transponder 120b at a predetermined distance. In certain embodiments, transponder 120a, b, and c may be embedded within different tread sections, but retain similar positioning relative to each other as described above. Tread 700 can represent one or more treads included in a typical tire, track, or track pad. Tread 700 can be present within inner, outer, and/or middle tread patterns. Reader 166 (not shown) can read the output generated by transponder 120a,b and c. Transponder 120a,b, and c can be positioned approximately overlapping one another. Transponder 120a,b, and c can be positioned in an offset manner relative to one another.

Program 112 can determine if unit 111 is functioning properly by determining whether reader 116 can detect the signal output of copies of transponders 120a, b, and c. If program 112 determines that neither transponder 120a, b, nor c are detected, program 122 generates notification A (discussed above). Subsequent to detecting vehicular motion, if program 112 determines that one or more of transponders 120a, b, or c are detected, program 122 begins to monitor the output from transponder 120a. In response to failing to detect output from transponder 120a, program 112 generates notification C (discussed above). Subsequently, program 112 monitors transponder output from transponder 120 b via antenna 118. If program 112 fails to detect output from transponder 120b, program 112 generates notification E.

Subsequently, program 112 proceeds to monitor, via antenna 118, output generated by transponder 120b. In response to program 112 failing to detect an output from transponder 120c, program 112 generates notification F. For example, notification F can reflect that a particular amount of tread 700 has been removed, for example, due to wear.

FIG. 8 illustrates the operational steps of a program, in accordance with an embodiment of the present invention. Program 112 determines whether transponders T1, T2, or T3 are detected (decisional 800). If program 112 determines transponders T1, T2, or T3 are not detected (“no” branch decisional 800), program 112 generates notification A (step 805). If program 112 determines transponders T1, T2, or T3 are detected (“yes” branch decisional 800), program 112 monitors transponder output (step 815). If program 112 detects transponder T1 (“yes” branch decisional 820), program 112 executes step 815. If program 112 does not detect transponder T1 (“no” branch decisional 820), program 112 generates notification E (step 825).

Program 112 monitors output from transponder T2 (step 830). If program 112 detects transponder T2 (“yes” branch decisional 835), program 112 executes step 830. If program 112 does not detect transponder T2 (“no” branch decisional 835), program 112 generates notification F (step 840). Program 112 monitors output from transponder T3 (step 845). If program 112 detects transponder T3 (“yes” branch decisional 850). If program 112 does not detect transponder T3 (“no” branch decisional 850), program 112 generates notification G (step 855).

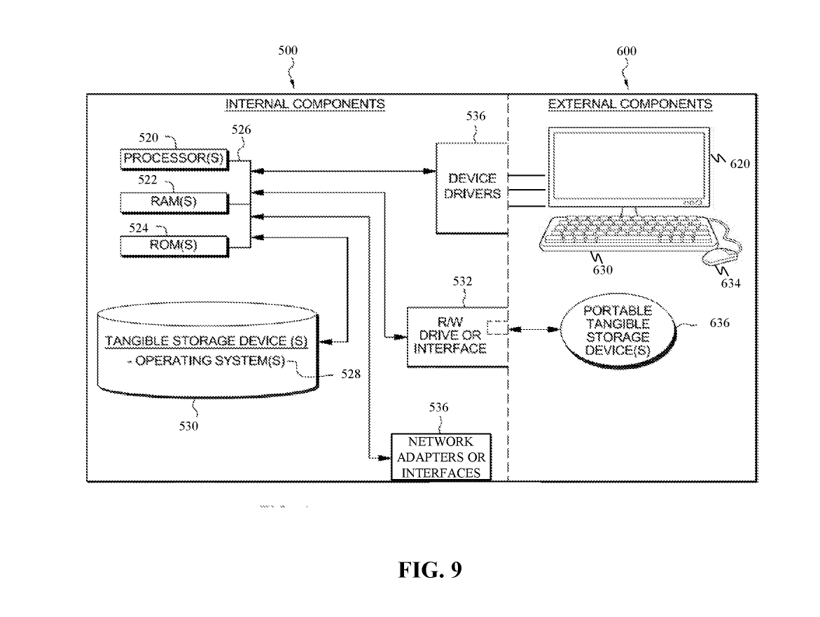

FIG. 9 depicts a block diagram of components of computing device 110, in accordance with an embodiment of the present invention. Data processing system 500, 600 is representative of any electronic device capable of executing machine-readable program instructions. Data processing system 500, 600 may be representative of a smart phone, a computer system, PDA, table, laptop, or other electronic devices. Examples of computing systems, environments, and/or configurations that may represented by data processing system 500, 600 include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

Computing device 110 includes respective sets of internal components 500 and external components 600 as illustrated in FIG. 9. Each of the sets of internal components 500 includes one or more processors 520, one or more computer-readable RAMs 522 and one or more computer-readable ROMs 524 on one or more buses 526, and one or more operating systems 528 and one or more computer-readable tangible storage devices 530. One or more of program 112 and transponder reading 114 are stored on one or more of the respective computer-readable tangible storage devices 530 for execution by one or more of processors 520 via one or more of the respective RAMs 522 (which typically include cache memory). In the embodiment illustrated in FIG. 9, each of the computer-readable tangible storage devices 530 is a magnetic disk storage device of an internal hard drive. Alternatively, each of the computer-readable tangible storage devices 530 is a semiconductor storage device, such as ROM 524, EPROM, flash memory or any other computer-readable tangible storage device that can store a computer program and digital information.

Internal components 500 also include a R/W drive or interface 532 to read from and write to one or more portable computer-readable tangible storage devices 636, such as a CD-ROM, DVD, memory stick, magnetic tape, magnetic disk, optical disk or semiconductor storage device. Program 112 and transponder readings 114 can be stored on one or more of the respective portable computer-readable tangible storage devices 636, read via the respective R/W drive or interface 532 and loaded into the respective computer-readable tangible storage devices 530.

Each set of internal components 500 also includes network adapters or interfaces 536 such as a TCP/IP adapter cards, wireless Wi-Fi interface cards, or 3G or 4G wireless interface cards or other wired or wireless communication links. Program 112 and transponder readings 114 can be downloaded to computing device 110, respectively, from an external computer via a network (for example, the Internet, a local area network or other, wide area network) and respective network adapters or interfaces 536. From the network adapters or interfaces 536, program 112 and transponder readings 114 in computing devices 110 are loaded into the respective computer-readable tangible storage devices 530. The network may comprise copper wires, optical fibers, wireless transmission, routers, firewalls, switches, gateway computers and/or edge servers.

Each of the sets of external components 600 can include a computer display monitor 620, a keyboard 630, and a computer mouse 634. External components 600 can also include touch screens, virtual keyboards, touch pads, pointing devices, and other human interface devices. Internal components 500 also include device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1: A track comprising:
a ground contacting element (“GCE”) comprising rubber;
an integrated circuit (“IC”) positioned within the GCE;
a conductive element positioned within the GCE;
wherein the conductive element is external to but in electrical communication with the IC;
wherein the conductive element is applied on an elastomer; and
wherein the conductive element comprises a conductive composition having fully exfoliated individual graphene sheets.

2: The track of claim 1, wherein the GCE is a track tread.

3: The track of claim 1, wherein the GCE is a track pad.

4: The track of claim 1, wherein the individual graphene sheets are present in the conductive composition in a three-dimensional connected network wherein individual graphene sheets are separated on at most a nanoscale basis.

5: The track of claim 1, wherein the conductive element is configured to rebroadcast a carrier signal.

6: The track of claim 1, wherein the conductive element is applied by printing, painting, and/or spraying.

7: The track of claim 1, wherein a plurality of IC conductive element pairs are positioned at various predetermined depths in the GCE, and wherein each pair is configured to broadcast a unique code in response to interrogation.

8: The track of claim 3, wherein the track pad is replaceable.

9: An tire tread comprising:
a GCE comprising rubber;
a plurality of pairs positioned within the GCE at predetermined depths;
wherein each pair includes an integrated circuit (“IC”) in electrical communication with a conductive element;
wherein the conductive element is applied on an elastomer; and
wherein the conductive element comprises a conductive composition having fully exfoliated individual graphene sheets;
wherein each pair is associated with a unique code.

10: The tire tread of claim 1, wherein the individual graphene sheets are present in the conductive composition in a three-dimensional connected network wherein individual graphene sheets are separated on at most a nanoscale basis.

11: The tire tread of claim 1, wherein the conductive element is applied by printing, painting, and/or spraying.

12: The tire tread of claim 1, wherein the conductive element is configured to rebroadcast a carrier signal.

13: A monitoring system comprising:
the track of claim 1;
a computing device configured to transmit a first carrier signal to the conductive element;
wherein the computing device is configured to determine an operational status of the GCE based on receiving a second carrier signal from the conductive element;
wherein the GCE comprises a track tread and/or a track pad.

14: The monitoring system of claim 13, wherein the computing device is configured to generate a notification in response to receiving the second carrier signal.

15: The monitoring system of claim 13, wherein the individual graphene sheets are present in the conductive composition in a three-dimensional connected network wherein individual graphene sheets are separated on at most a nanoscale basis.

16: The monitoring system of claim 13, wherein a plurality of IC conductive element pairs are positioned at various predetermined depths in the GCE, and wherein each pair is configured to broadcast a unique code in response to interrogation.

17: The track monitoring system of claim 13, wherein the track pad is replaceable.
